(19) United States
(12) Patent Application Publication
(10) Pub. No.: US 2004/0177815 A1
(43) Pub. Date: Sep. 16, 2004

(54) Pet diner

(76) Inventor: James R. Sage JR., Cyclone, PA (US)

Correspondence Address: Ansel M. Schwartz, Suite 304, 201 N. Craig Street, Pittsburgh, PA, 15213, US

(21) Appl. No.: 10/368,833

(22) Filed: Feb. 19, 2003

(51) Int. Cl. A01K 1/10; A01K 5/00; A01K 39/00

(52) U.S. Cl. 119/61.3

(57) ABSTRACT

A diner for a pet. The diner includes a tray for holding food. The diner includes a housing having a chamber large enough for the pet to stand in, a doorway connected to the chamber through which the pet enters and exits the chamber, and a slot which communicates with the chamber in which the tray removably fits and extends into the chamber so the pet can eat the food while in the chamber. A method of feeding a pet. The method includes the steps of opening a lid over a compartment of a housing.

### FIELD OF THE INVENTION

The present invention pertains to a diner for feeding a pet. More specifically, the present invention pertains to a diner for feeding a pet that is enclosed to limit access to the food by larger dogs, is easy to clean, can store supplies for the pet, and provides a bed for the pet.

### BACKGROUND OF THE INVENTION

A common problem that pet owners have is that dogs like to eat cat food and big dogs like to eat little dogs' food. How many times has one seen cat food bowls on the top of a refrigerator or kitchen counter, and not on the floor. The food bowls are in those locations to keep them away from the bigger family pet dog. In addition, the problem with cats and dogs is that they are messy eaters, typically dropping food all around their bowls. Moreover, the pet's food needs to be stored somewhere and typically takes up storage space that could otherwise be used by the pet owner to store other objects in the kitchen.

The present invention, designed to resemble a New Jersey style diner, prevents a larger dog from eating the pet's food, contains the food to an area that can be easily cleaned, and allows for storage of the pet's food essentially in the area the pet eats.

### SUMMARY OF THE INVENTION

The present invention pertains to a diner for a pet, such as a cat or a dog. The diner comprises a tray for holding food. The diner comprises a housing having a chamber large enough for the pet to stand in, a doorway connected to the chamber through which the pet enters and exits the chamber, and a slot which communicates with the chamber in which the tray removably fits and extends into the chamber so the pet can eat the food while in the chamber.

The present invention pertains to a method of feeding a pet. The method comprises the steps of opening a lid over a compartment of a housing. There is the step of removing a package of food from the compartment. There is the step of opening the package. There is the step of placing the food in the package into a tray. There is the step of sliding the tray into a chamber of the housing through a slot in the housing. There is the step of allowing the pet to enter a doorway of the housing to enter the chamber and eat the food in the tray. There is the step of removing the tray from the slot. There is the step of cleaning the tray.

### BRIEF DESCRIPTION OF THE DRAWINGS

In the accompanying drawings, the preferred embodiment of the invention and preferred methods of practicing the invention are illustrated in which:

FIG. 1 is a prospective view of a diner of the present invention.

FIG. 2 is a view of the tray and the housing.

FIG. 3 is a view of the doorway of the diner.

FIG. 4 is a view of the compartment with the lid partially open having pet food in it of the diner.

FIG. 5 is a view of the compartment with the lid open having pet food in it.

FIG. 6 is a view of the diner with a cat resting on the pad.

FIG. 7 is the view of the base with the tray.

FIG. 8 is a view of the base with the tray partially inserted into the base.

FIG. 9 is a view of the base with one wall.

FIG. 10 is a view of the base with a wall having windows and a wall with the doorway.

FIG. 11 is a view of the base with walls having windows and a wall with the doorway.

FIG. 12 is a view of the base with walls extending around its perimeter.

FIG. 13 is a view of the diner without the pad.

### DETAILED DESCRIPTION

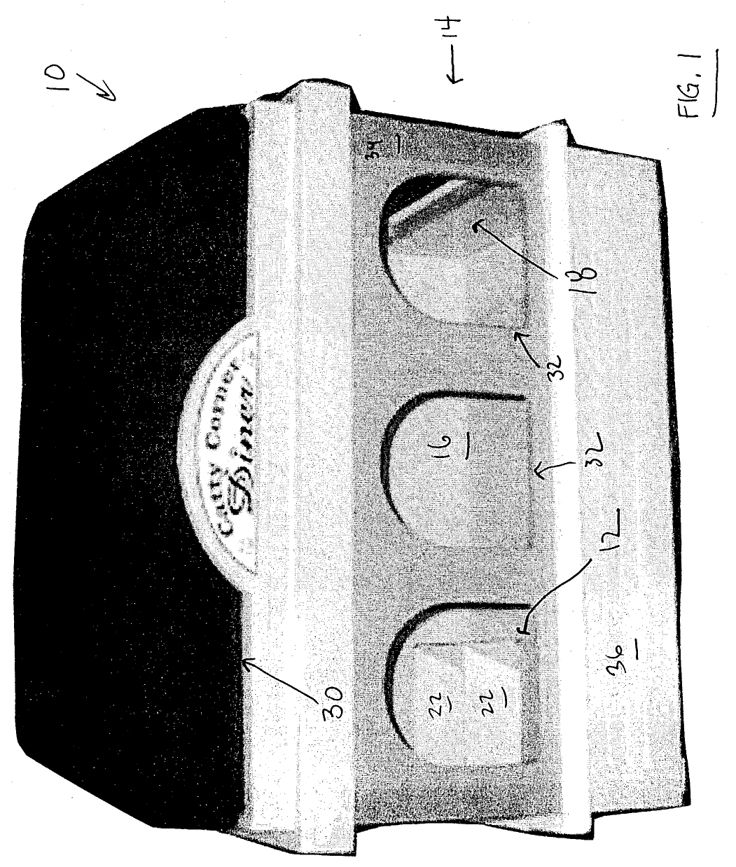

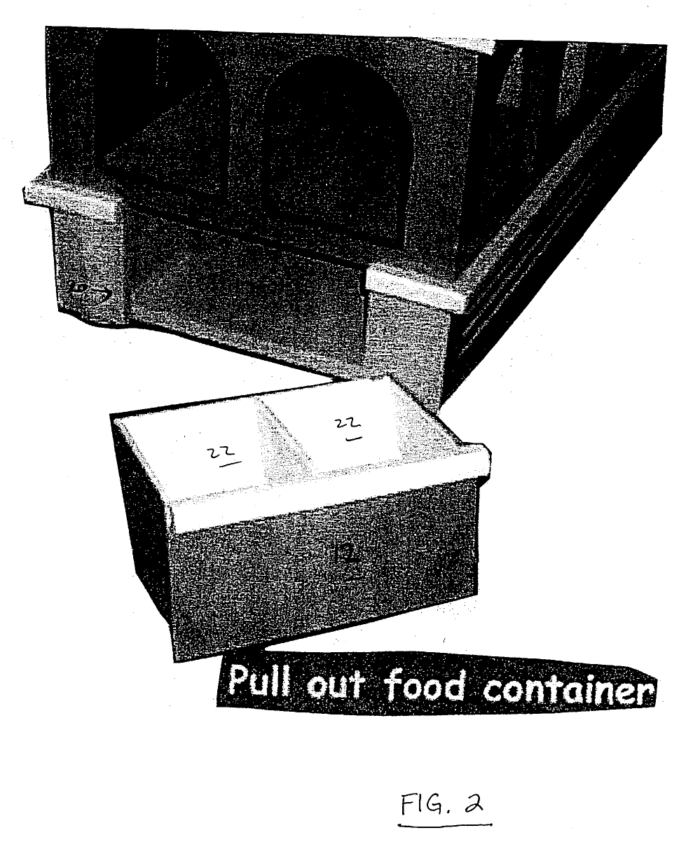

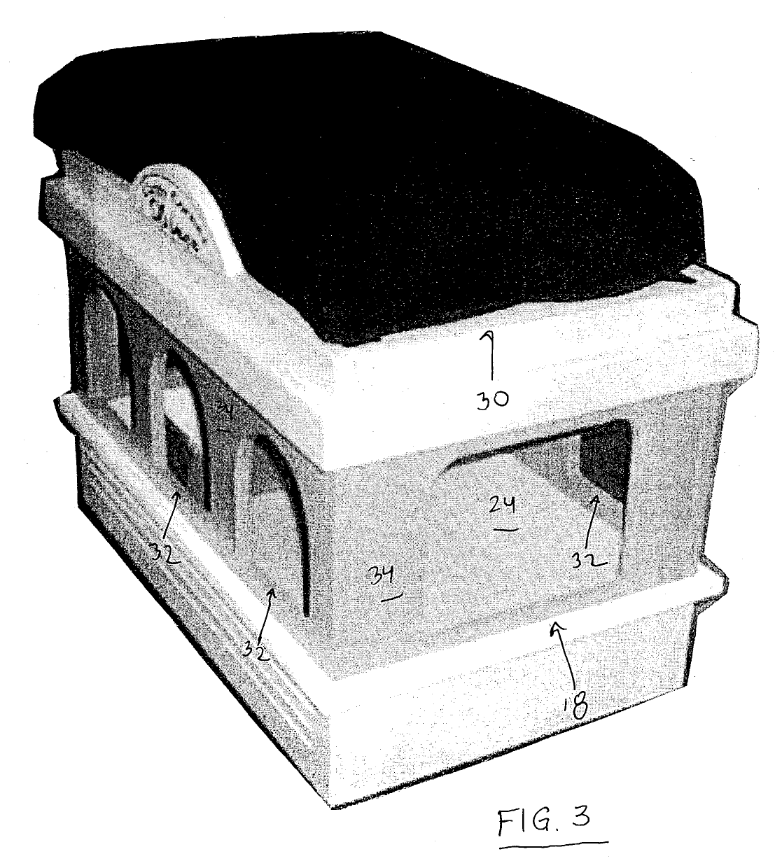

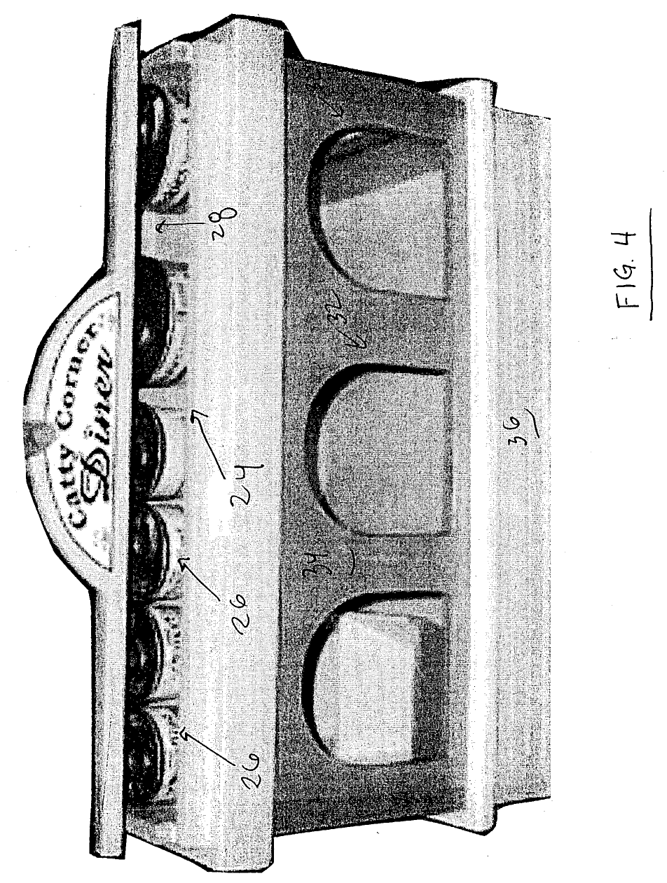

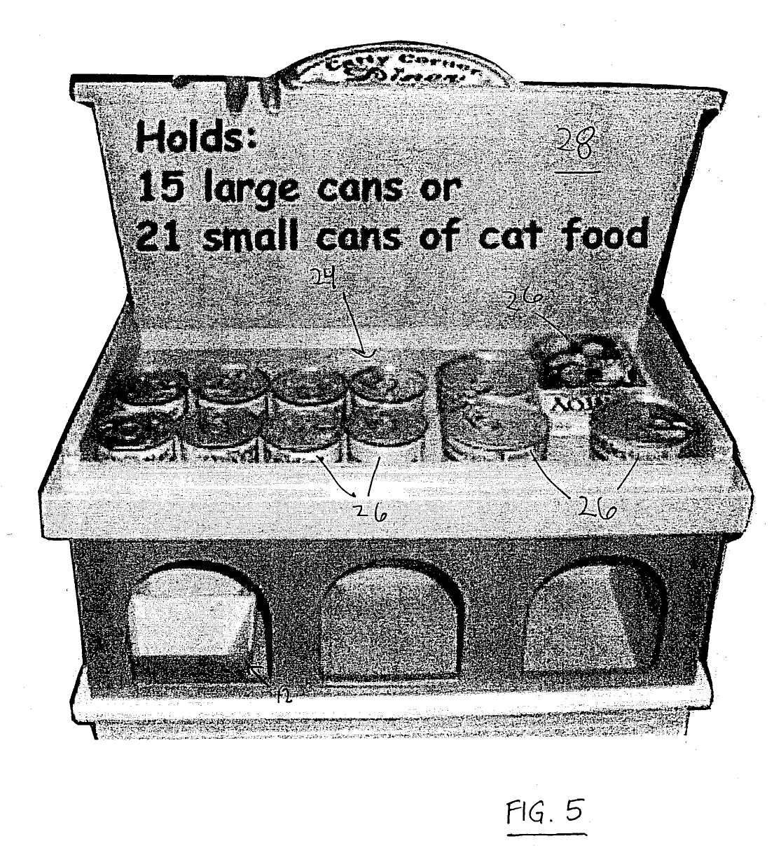

Referring now to the drawings wherein like reference numerals refer to similar or identical parts throughout the several views, and more specifically to FIGS. 1-6 thereof, there is shown a diner 10 for a pet, such as a cat or a dog. The diner 10 comprises a tray 12 for holding food. The diner 10 comprises a housing 14 having a chamber 16 large enough for the pet to stand in, a doorway 18 connected to the chamber 16 through which the pet enters and exits the chamber 16, and a slot 20 which communicates with the chamber 16 in which the tray 12 removably fits and extends into the chamber 16 so the pet can eat the food while in the chamber 16.

Preferably, the tray 12 has at least two troughs 22 for holding food or liquid. The housing 14 preferably has a compartment 24 for storing objects 26, and a lid 28 which covers the compartment 24. Preferably, the housing 14 has hinges which are connected to the lid 28 that allows the lid 28 to open and close with respect to the compartment 24. The diner 10 preferably includes a pad 30 disposed on the lid 28 on which the pet lies.

Preferably, the housing 14 has windows 32 disposed about the chamber 16 that communicates with the chamber 16. The housing 14 preferably has a base 36 on which the pet stands. Preferably, the housing 14 has detachable walls 34 which fit on the base 36, the windows 32 disposed in the walls 34. The compartment 24 preferably fits on the walls 34.

The present invention pertains to a method of feeding a pet. The method comprises the steps of opening a lid 28 over a compartment 24 of a housing 14. There is the step of removing a package of food from the compartment 24. There is the step of opening the package. There is the step of placing the food in the package into a tray 12. There is the step of sliding the tray 12 into a chamber 16 of the housing 14 through a slot 20 in the housing 14. There is the step of allowing the pet to enter a doorway 18 of the housing 14 to enter the chamber 16 and eat the food in the tray 12. There is the step of removing the tray 12 from the slot 20. There is the step of cleaning the tray 12.

There are preferably the steps of lifting the compartment 24. There is the step of lifting walls 34 of the housing 14 off of a base 36 of the housing 14. There is the step of cleaning the base 36. There is the step of placing the walls 34 back into the base 36. There is the step of placing the compartment 24 on the walls 34.

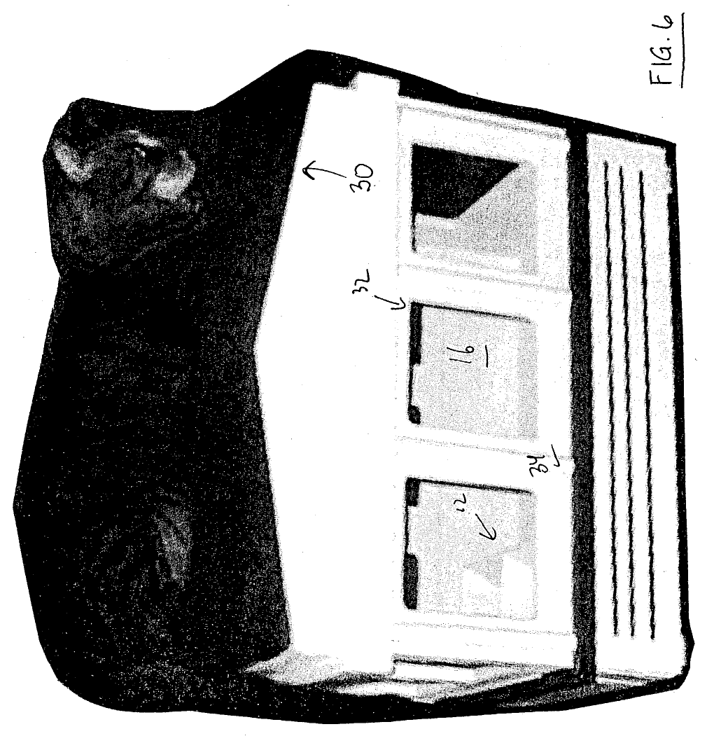

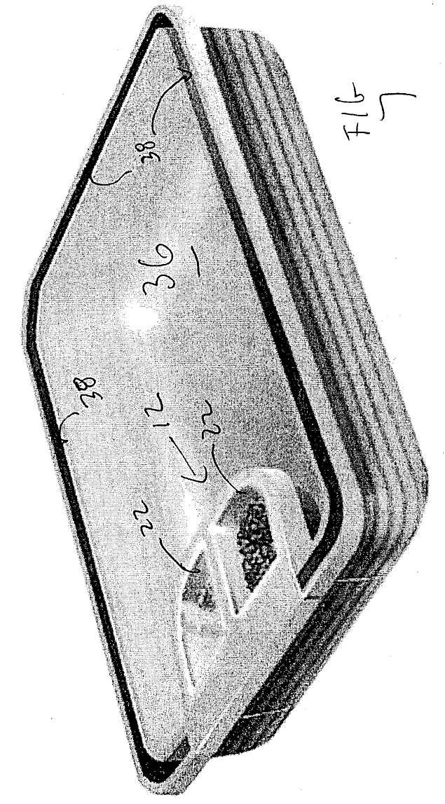

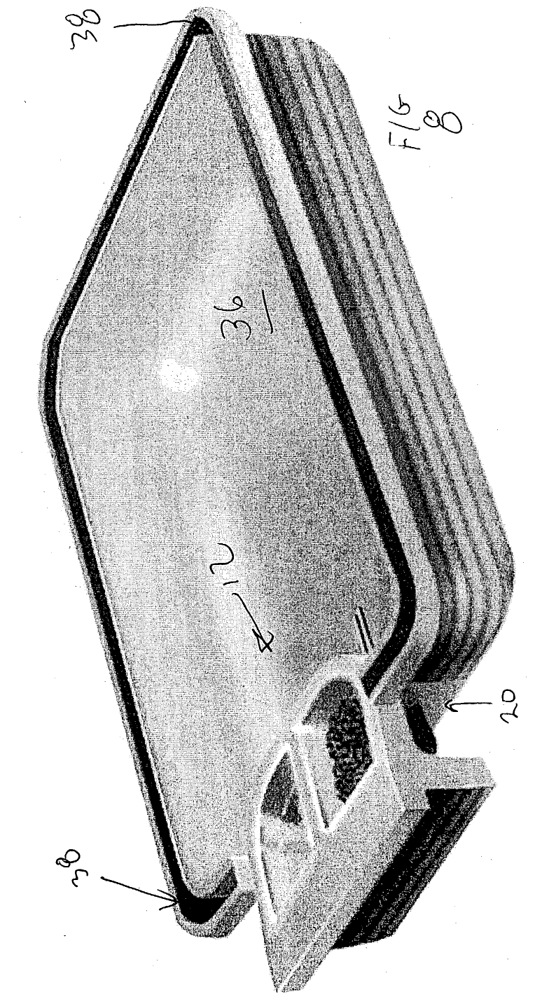

In the operation of the invention, one trough 22 of the tray 12 is filled with cat food, and another trough 22 of the tray 12 is filled with water. The tray 12 is then inserted into a slot 20 of the housing 14 so that it extends into the chamber 16 of the housing 14, as shown in FIGS. 7 and 8. There are tracks on the base 36 of the housing 14 in the slot 20 that aligns with grooves in the tray 12 that guide the tray 12 into the slot 20 in the chamber 16 of the housing 14. Referring to FIGS. 1-5, the cat then enters the doorway 18 of the housing 14 to gain access to the chamber 16. The cat, typically standing in the chamber 16, then eats the cat food and drinks water out of the tray 12 in the chamber 16. The cat is completely enclosed in the chamber 16 by the housing 14, although there are windows 32 in the walls 34 of the housing 14 through which the cat can look. When the cat is through eating and drinking, the cat simply turns around, or backs out of the chamber 16 through the doorway 18. The cat can then hop on top of the housing 14 and lay down and rest on a pad 30 on top of the housing 14, as shown in FIG. 6.

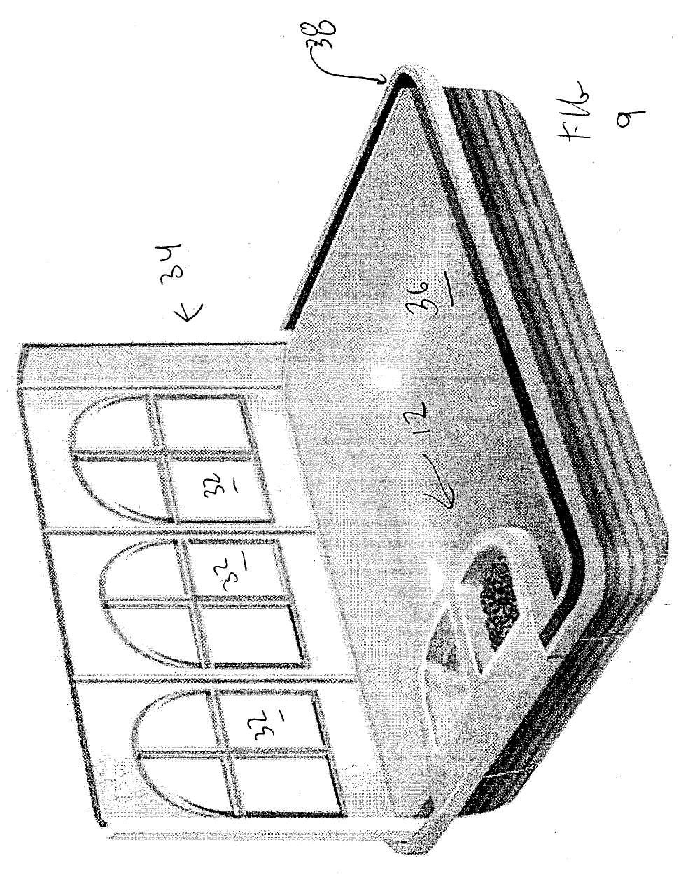

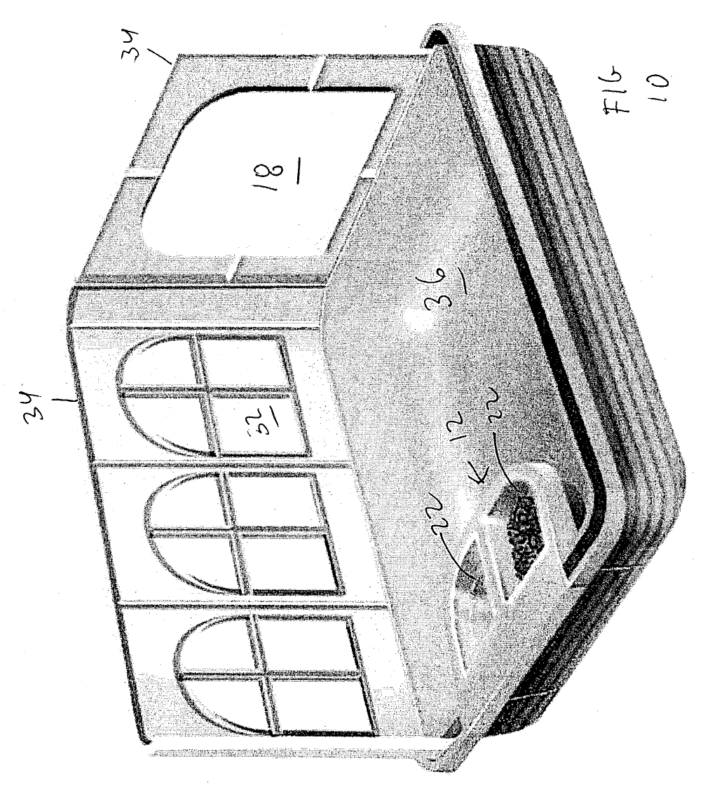

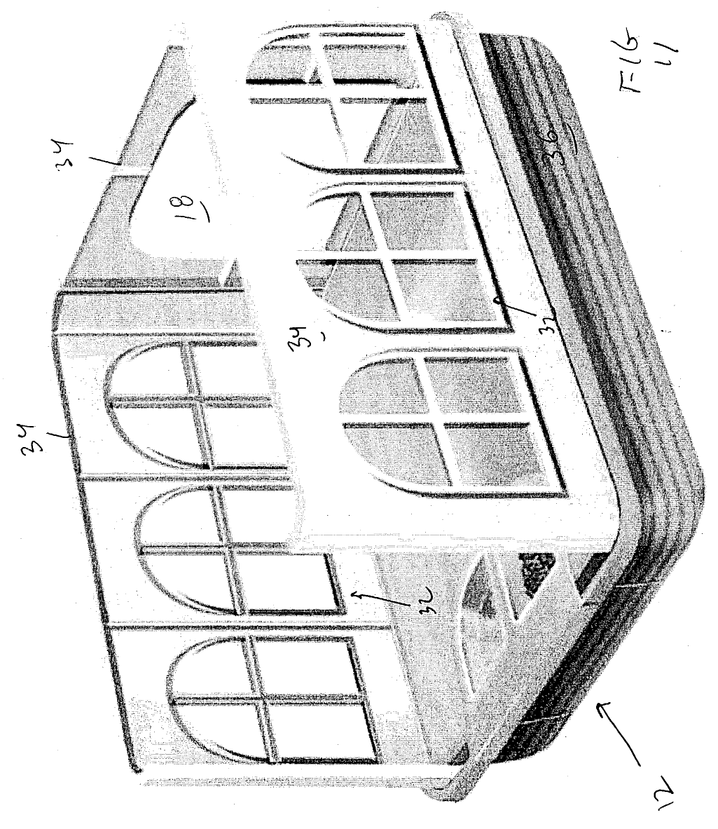

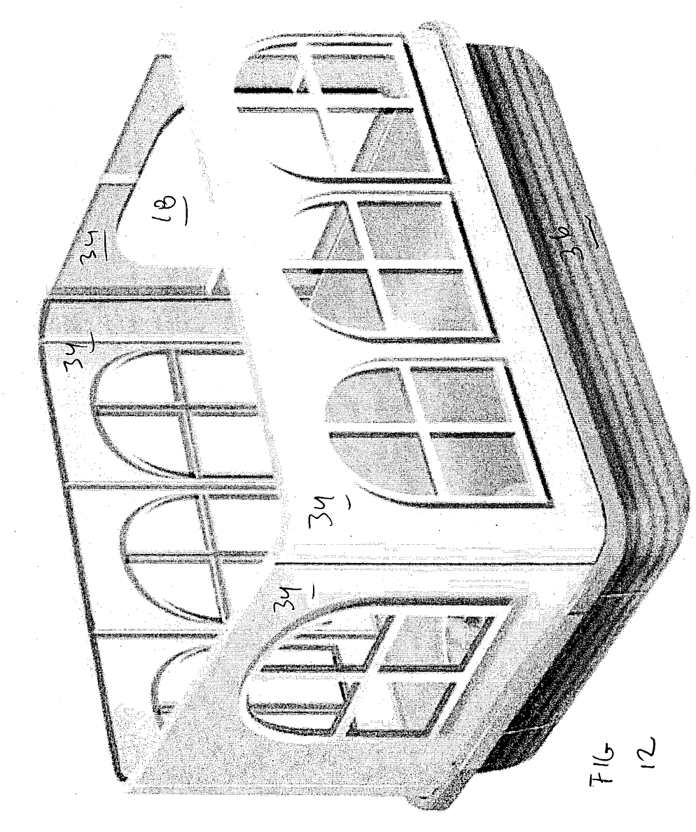

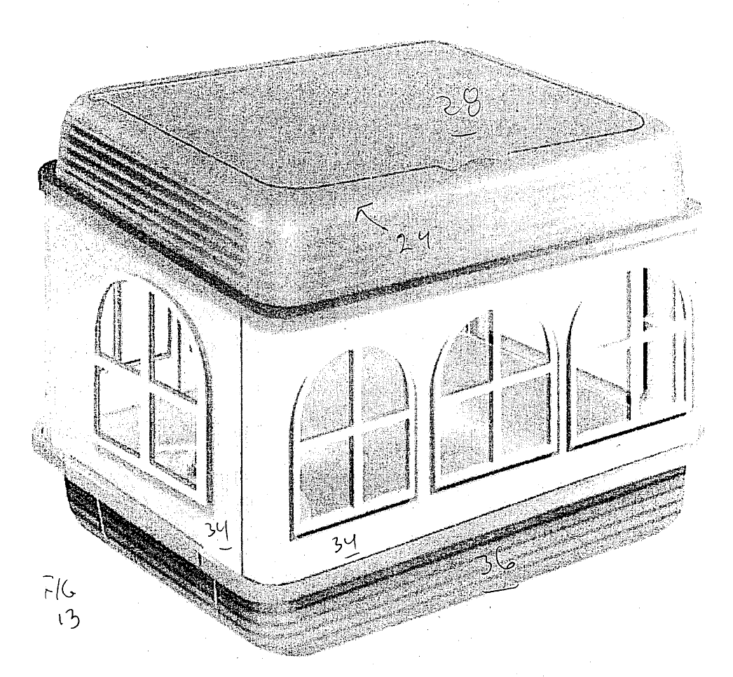

After the cat has finished eating and drinking, the tray 12 can be removed from the housing 14 from the slot 20 and washed off. Similarly, the base 36 and the interior walls 34 of the housing 14 can be washed off by removing the compartment 24 having the pad 30 on top of it, and then each of the four walls 34 from the base 36, and then individually cleaning each piece as desired. After cleaning, the diner 10 is reconstructed by inserting each wall into its respective notch 38 which runs along the perimeter of the base 36 (see FIGS. 9-12). The compartment 24 is then fitted on top of the walls 34 through notches 38 that hold the compartment 24 to the walls 34 to complete the reconstruction of the diner 10, as shown in FIG. 13. In this manner, the diner 10 is first also constructed after it is removed from the box in which it is packaged.

When it is time to fill the tray 12 with food, a lid 28 over the compartment 24 is lifted and packages having the cat food which are stored in the compartment 24, are removed and opened. The food from the package is then poured into the tray 12. The lid 28 is shut over the compartment 24 allowing the diner 10 to serve as a resting spot for the cat on the pad 30.

The base 36 and the tray 12 are preferably made of plastic, and the walls 34 and the compartment 24 are preferably made of wood. However, the base 36, tray 12, walls 34 and the compartment 24 can be made out of metal or ceramic or any material that is convenient and light weight and can be easily cleaned. The pad 30 and the compartment 24 are held together by hook and loop fasteners, commonly known as Velcro.

It should be noted that the above description is also applicable to other pets, such as dogs.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A diner for a pet comprising:
a tray for holding food; and
a housing having a chamber large enough for the pet to stand in, a doorway connected to the chamber through which the pet enters and exits the chamber, and a slot which communicates with the chamber in which the tray removably fits and extends into the chamber so the pet can eat the food while in the chamber.

2. A diner as described in claim 1 wherein the tray has at least two troughs for holding food or liquid.

3. A diner as described in claim 2 wherein the housing has a compartment for storing objects, and a lid which covers the compartment.

4. A diner as described in claim 3 wherein the housing has hinges which are connected to the list that allows the lid to open and close with respect to the compartment.

5. A diner as described in claim 4 including a pad disposed on the lid on which the pet lies.

6. A diner as described in claim 5 wherein the housing has windows disposed about the chamber that communicates with the chamber.

7. A diner as described in claim 6 wherein the housing has a base on which the pet stands.

8. A diner as described in claim 7 wherein the housing has detachable walls which fit on the base, the windows disposed in the walls.

9. A diner as described in claim 8 wherein the compartment fits on the walls.

10. A method of feeding a pet comprising the steps of:
opening a lid over a compartment of a housing;
removing a package of food from the compartment;
opening the package;
placing the food in the package into a tray;
sliding the tray into a chamber of the housing through a slot in the housing;
allowing the pet to enter a doorway of the housing to enter the chamber and eat the food in the tray;
removing the tray from the slot; and
cleaning the tray.

11. A method as described in claim 10 including the steps of:
lifting the compartment;
lifting walls of the housing off of a base of the housing;
cleaning the base;
placing the walls back into the base; and
placing the compartment on the walls.
